(19) United States
(12) Patent Application Publication
(10) Pub. No.: US 2021/0004716 A1
(43) Pub. Date: Jan. 7, 2021

(54) REAL-TIME GLOBAL AI PLATFORM

(71) Applicant: Visa International Service Association, San Francisco, CA (US)

(72) Inventors: Hongqin Song, Austin, TX (US); Yu Gu, Austin, TX (US); Shawn Johnson, Geogetown, TX (US); Kalpana Jogi, Foster City, CA (US); Claudia Barcenas, Austin, TX (US); Xu Wang, Foster City, CA (US)

(21) Appl. No.: 16/503,060

(22) Filed: Jul. 3, 2019

(51) Int. Cl. G06N 20/00; G06F 16/2455

(52) U.S. Cl. CPC G06N 20/00; G06F 16/2455

(57) ABSTRACT

A global AI platform and a method for generating aggregated and ordered data sets are disclosed. Aggregated and ordered data sets are data sets that have been grouped, ordered, and for which one or more data values in the data set have been aggregated. As a result of their aggregation and ordering, aggregated and ordered data sets can be retrieved from a database and used more quickly than non-ordered, non-aggregated data sets. A data processor computer can receive a plurality of data sets, and from those data sets generate aggregated and ordered data sets that can subsequently be stored in an aggregated and ordered database. A data service computer can retrieve a subset of the aggregated and ordered data sets from the database, and use the subset as an input to an AI model that can be used to generate predictions that can be delivered to clients.

### BACKGROUND

Forecasting and prediction are activities that frequently influence decision making. People rely on weather forecasts in order to decide where they will go and what they will do, businesses rely on business forecasts to direct the flow of capital, and governments rely on climate forecasts to develop public policy. These entities and others often evaluate the quality of forecasts based on their accuracy and speed. Entities desire more accurate forecasts that are delivered to them at greater speed.

Determining the accuracy of a forecast takes time, especially if a forecast is for the distant future, as an entity has to compare the forecast to the events or conditions that eventually come to pass. For example, a weather forecast corresponding to a day 20 years from now cannot be verified until 20 years come to pass. Determining the speed of a forecast is easier, and is one way that entities evaluate the quality of forecasts.

Slow forecasting speeds can negatively impact the experience of entities and the quality of their decision making. This is particularly true when businesses compete to provide forecasts for customers. For example, if one weather forecasting company takes five minutes to return a forecast, and a competing company only takes one minute, the competing company has an advantage, as customers prefer to wait a shorter amount of time.

In recent years, artificial intelligence (AI) and machine learning have been used to provide forecasts and predictions. AI and machine learning techniques allow computer systems to quickly and accurately provide forecasts based on input data. For example, a machine learning model can be trained to predict whether or not it will rain based on the barometric pressure, temperature, wind speed, etc. Machine learning models can typically discover relationships between inputs and outputs that would be missed by human predictors or older automated prediction techniques.

Simultaneously, as part of the “big data” trend, based on the belief that more data improves the quality of forecast, entities are using increasingly large data sets as inputs to forecasting models. This however poses a problem. While accuracy may increase as a result of increasing the quantity of data, the speed of forecasting often decreases greatly. While clients or customers are often the beneficiaries of higher quality forecasting, their experience is simultaneously degraded by the decrease in speed.

Embodiments of the present disclosure address these and other problems, individually and collectively.

### SUMMARY

Embodiments of the present disclosure are directed to methods and systems for generating and using aggregated and ordered data sets, particularly in conjunction with a global AI platform. The global AI platform may use the aggregated and ordered data sets to generate predictions that may be related to time and geographic location. These predictions may be requested and delivered to clients. For example, the global AI platform may be used to predict how many sales will be made by a particular merchant category (e.g., movie theaters) in a particular region (e.g., Austin Tex.) six months into the future. As another example, the global AI platform may be used to predict the pollution output (e.g., tons of additional atmospheric carbon dioxide) of a particular region six months into the future. The global AI platform may also operate as a data service, and deliver data from the aggregated and ordered data sets to requestors (e.g., clients).

The global AI platform may comprise a data processor computer and a data service computer. The data processor computer may generate aggregated and ordered data sets. The data service computer may receive requests from clients (such as requests for data sets or requests for predictions. The data service computer may retrieve a subset of data from the aggregated and ordered data sets and provide that data to the client, or use that data along with an artificial intelligence module to produce a prediction that can then be delivered to the client.

In some embodiments, the data processor computer and the data service computer may be the same computer, i.e., the global AI platform may comprise a single computer system. In other embodiments, functions of the data processor computer and data service computer may be carried out by multiple computer systems.

Data sets, as introduced above, may correspond to interaction events. An interaction event may relate to an interaction that took place, such as a transaction between a merchant and a customer. Another example of an interaction event is a pollution event, e.g., an event where some quantity of a pollutant is ejected by a polluter into the atmosphere. A data set may comprise a number of data values and each data value may have a corresponding data type. A data set corresponding to a transaction may have data values corresponding to the location of the transaction, the time the transaction took place (e.g., a timestamp) and the amount spent on the transaction. Location, time and amount spent are all examples of data types. A data set corresponding to a pollution event may have data values corresponding to the location of the pollution event, the time the pollution event took place, the type of pollutant, and the mass and/or volume of the pollutant.

Aggregated and ordered data sets may refer to a collection of data sets that have been aggregated and ordered by the data processor computer using the methods described in the detailed description below. Generally, aggregated and ordered data sets are ordered in both groups and sequences. A group of data sets may comprise data sets that have common data values of a common data type. For example, for data sets corresponding to transactions, each data set may comprise a data value corresponding to the location of the transaction, such as a zip code. A group of data sets may comprise data sets with a common zip code, such as a group of data sets that each have the zip code 94612. Groups of data sets may be further ordered based on parameters such as time, or data values such as a common data type. For example, a group of data sets corresponding to transactions in the zip code 94612 may be ordered based on the time those transactions took place, such that the data set corresponding to the earliest transaction is the first data set in the group, and that the data set corresponding to the latest transaction is the last data set in the group. This ordering may be accomplished using data values such as timestamps.

These ordered groups of data sets may subsequently be aggregated. In an aggregated group of data sets, some data values in each data set are converted to aggregate values. These aggregate data values may take the form of cumulative totals of their corresponding data values. For example, in an ordered (not aggregated) group of data sets corresponding to transactions in a particular zip code, each data set may comprise a data values corresponding to the amount spent in that particular transaction (e.g., $10.00). However, in an exemplary aggregated and ordered group of data sets, each data set may comprise a data value corresponding to the cumulative total spent on that transaction and all previous transactions.

In order to illustrate data set aggregation, the following examples of ordered aggregated and non-aggregated groups of data sets are provided. The following are examples of data sets in an ordered (not aggregated) group of data sets corresponding to transaction interaction events:

[zip code: 94612, timestamp: Monday, amount spent: $5.00]

[zip code: 94612, timestamp: Tuesday, amount spent: $4.00]

[zip code: 94612, timestamp: Wednesday, amount spent: $8.00]

[zip code: 94612, timestamp: Thursday, amount spent: $9.00]

[zip code: 94611, timestamp: Friday, amount spent: $10.00]

The following are examples of data sets in an aggregated and ordered group of data sets, corresponding to the data sets above:

[zip code: 94612, timestamp: Monday, amount spent: $5.00]

[zip code: 94612, timestamp: Tuesday, amount spent: $9.00]

[zip code: 94612, timestamp: Wednesday, amount spent: $17.00]

[zip code: 94612, timestamp: Thursday, amount spent: $26.00]

[zip code: 94612, timestamp: Friday, amount spent: $36.00]

As can be verified, data values corresponding to amount spent are cumulative. The amount spent data value for the data set corresponding to Friday includes the amount spent in all previous days in the aggregated and ordered group of data sets.

The data processor computer can store all aggregated and ordered groups of data sets in an aggregated and ordered database. A data service computer can retrieve a subset of the aggregated and ordered data sets and use the subset to generate predictions or otherwise deliver data to clients.

Generally, because of their aggregation and ordering, aggregated and ordered data sets can be retrieved from the aggregated and ordered database more quickly than conventional data sets. Because aggregated and ordered data sets are organized in groups based on common data values, indices can be used to quickly locate groups of data sets in the aggregated and ordered database. An index can correspond to a particular data value or a collection of data values for a particular data type. For example, an index can correspond to a zip code such as 94612 or a collection of zip codes, such as all zip codes corresponding to a particular state. Using the index, a data service computer can quickly identify the relevant group of data sets.

Typically, for a database that is unordered, in order to find all data sets corresponding to a particular database value, each and every data set has to be evaluated to determine if it has the desired data value (e.g., a desired zip code). This becomes infeasible for large databases comprising large numbers of data sets. Using an index however, the data service computer can quickly navigate to data sets corresponding to the index, saving a considerable amount of time in the process.

Likewise, the aggregation of data sets saves a considerable amount of time when the data sets are user by the data service computer in order to generate a prediction, e.g., by a machine learning model or other application of artificial intelligence. Machine learning models often take a feature vector as an input. The feature vector can include a vectorized collection of components. These components may include, for example, total or aggregate values. As an example, a machine learning model may be used to predict the sales of a particular business over a six month period in the future. One of the components of the feature vector may be the sales of the business over a six month period in the past, based on the observation that the sales in the near future are closely correlated to the sales in the near past. The sales over a six month period in the past are an aggregate data value, as they comprise a total of many sales that occurred over that time period.

In a conventional system, where data sets are not aggregated and ordered, that data service computer must first aggregate the data values itself before making the prediction. As such, the data service computer would have to retrieve all data sets corresponding to the six month period, then sum the data values in order to generate a single component of the feature vector used as an input to the machine learning model. For large numbers of data sets, this process may take a considerable amount of time. As a result, aggregating during or immediately prior to prediction may be unfeasible for real-time applications.

However, because embodiments provide for aggregated and ordered data sets, determining aggregate values takes considerably less time. In order to calculate the total amount of some data value (e.g., sales, pollution), the data service computer only needs to retrieve two data sets, one corresponding to the beginning of the time period (e.g., six months ago) and one corresponding to the end of the time period (e.g., the present time), and only needs to perform a single subtraction operation, regardless of the total number of interaction events that took place over that time period. This is particularly useful for big databases, as it can be performed in constant time complexity regardless of the size of the database.

This property can be illustrated using the example data sets above. To calculate the total amount spent between Tuesday and Friday, a conventional system must retrieve the data sets corresponding to Tuesday, Wednesday, Thursday, and Friday, and sum the amount spent data values ($4.00+$8.00+$9.00+$10.00=$31.00). By contrast, with embodiments, the data service computer only needs to retrieve the aggregated and ordered data sets corresponding to Monday and Friday, and subtract the aggregated Monday data value from the aggregated Friday data value ($36.00-$5.00=$31.00). As can be verified, the method according to embodiments involves two less database retrieval operations and two less addition/subtraction operations, increasing the speed of the process.

An experiment performed by the inventors demonstrates the speed and efficacy of methods according to embodiments. For 99.5% of aggregate and ordered database calls, it took less than 10 milliseconds to complete the call. Likewise Tensorflow and PMML models produced predictions in under 20 milliseconds for 99.5% of calls. The total process time (i.e., the time between when a request was made and the resulting prediction or data was delivered) was less than 100 milliseconds for 99.5% of calls. These statistics demonstrate the speed improvements resulting from methods according to embodiments.

One embodiment is directed to a method comprising: receiving, by a data service computer, a request from a requestor; generating, by the data service computer, a query of an aggregated and ordered database based on the request; querying, by the data service computer, the aggregated and ordered database using the query to obtain a subset of data from an aggregated and ordered data set; and providing, by the data service computer, the subset of data to the requestor.

Another embodiment is directed to the above-noted method, further comprising: receiving, by a data processor computer, a plurality of data sets corresponding to a plurality of interaction events, each data set comprising a plurality of data values of different data types; generating, by the data processor computer, one or more groups of data sets, each group comprising one or more data sets having common data values of a common data type; within each of the one or more groups of data sets, ordering, by the data processor computer, the one or more data sets in each group according to time to form an ordered group of data sets; within each ordered group of data sets, for each data set, determining, by the data processor computer, an aggregated data value for a data type, the aggregated data value determined by aggregating a data value corresponding to the data type for the data set with a cumulative total of data values of the data type for all preceding data sets in the ordered group of data sets, thereby creating an aggregated and ordered group of data sets; and storing, by the data processor computer, a plurality of aggregated and ordered data sets in the aggregated and ordered database, wherein the plurality of aggregated and ordered data sets are a plurality of aggregated and ordered groups of data sets.

Another embodiment is directed to a data service computer comprising: a processor; and a non-transitory computer readable medium coupled to the processor; the non-transitory computer readable medium comprising code, executable by the processor for implementing either of the above-noted methods.

### Terms

A “server computer” may include a powerful computer or cluster of computers. For example, the server computer can be a large mainframe, a minicomputer cluster, or a group of servers functioning as a unit. In one example, the server computer may be a database server coupled to a web server. The server computer may comprise one or more computational apparatuses and may use any of a variety of computing structures, arrangements, and compilations for servicing the requests from one or more client computers.

A “memory” may be any suitable device or devices that may store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

“Entities” may include things with distinct and independent existence. For example, entities may include people, organizations (e.g., partnerships and businesses), computers, and computer networks, among others. An entity can communicate or interact with its environment in some manner. Further, an entity can operate, interface, or interact with a computer or computer network during the course of its existence.

A “requestor” may refer to an entity that makes requests of other entities. A “request” may refer to a message or other communication asking for something. As examples, a request for data stored on a hosting server, a request for confirmation of receipt of another message, or a request for executable code or other instructions.

A “client” may refer to an entity that receives or uses the services of another entity. For example, a client may refer to a human that receives a service from another human, such as the client of a law firm. As another example, a client may refer to a computer system that receives a service from another computer system, such as a desktop computer that receives applications or data from a remote server computer. A computer system owned or operated by a client may be referred to as a “client terminal.”

An “interaction” may refer to a reciprocal action, effect or influence. For example, an interaction could be an exchange or transaction between two or more parties. An interaction that takes place may be referred to as an “interaction event.”

A “data type” may refer to a qualifier for data. A data type may label or define data or a set of data. For example, “height measurement” is a data type that qualifies that a “data value” such as “160 cm” is a measurement of the height of some object or entity. Other examples of data types include “location,” indicating that an associated data value corresponds to location and “timestamp,” indicating that an associated data value refers to a point in time.

A “data value” may refer to a value corresponding to data. Data values may be quantitative (e.g., height, weight, age) and may correspond to units of measurement (cm, kg, years). Alternatively, data values may be quantitative (e.g., color, location, desirability). Examples of data values include 160 cm, the zip code 94612, the timestamp 2018-12-12-2:14:00 A.M., among others.

A “data set” may refer to a collection of data values. A data set may also include data types or labels corresponding to the data values. Often data values in a data set share one or more characteristics or relate to the same concept, source, or entity. For example, a data set may comprise data values corresponding to a person's vital statistics (e.g., height, weight, age, blood type, etc.). As another example, a data set may comprise data values corresponding to interaction event information, such as transaction information (e.g., location of transaction, time transaction took place, amount spent, etc.) A “subset” of data may refer to a data set contained within a data set of greater size.

A “database” may refer to a set of data or sets of data stored in a computer. Alternatively, a database may refer to the code, instructions, file system, or other structure used to hold the set or sets of data. The term database may include related concepts, such as “data lakes,” “data warehouses,” “data repositories,” etc.

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on a “feature vector” or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines, models that classify data by establishing a gap or boundary between inputs of different classifications, as well as neural networks, collections of artificial “neurons” that perform functions by activating in response to inputs.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex input, such as a human entity, an exemplary feature vector could include features such as the human's age, height, weight, a numerical representation of relative happiness, etc. Feature vectors can be represented and stored electronically in a feature store. Further, a feature vector can be normalized, i.e., be made to have unit magnitude. As an example, the feature vector (12, 15, 22, 5) corresponding to “LOVE” could be normalized to approximately (0.40, 0.51, 0.74, 0.17).

A “string” may refer to a sequence of similar items. For example, a string may refer to a linear sequence of characters, words or other data. “Hello World” is an example of a string comprising a linear sequence of alphanumeric characters. Strings may be used to represent data sets, and data sets may be stored in databases as strings.

### BRIEF DESCRIPTION OF THE DRAWINGS

FIG. 1 shows a system block diagram of a real-time global AI platform according to some embodiments.

FIG. 2 show a flowchart of a method performed by a data processor computer according to some embodiments.

FIG. 3 shows a flowchart of a method performed by a data service computer according to some embodiments.

FIG. 4 shows exemplary data sets according to some embodiments

FIG. 5 shows exemplary aggregated and ordered data sets according to some embodiments.

FIG. 6A shows a diagram of training a machine learning model for time-based prediction according to some embodiments.

FIG. 6B shows a diagram of utilizing a machine learning model for time-based prediction according to some embodiments.

### DETAILED DESCRIPTION

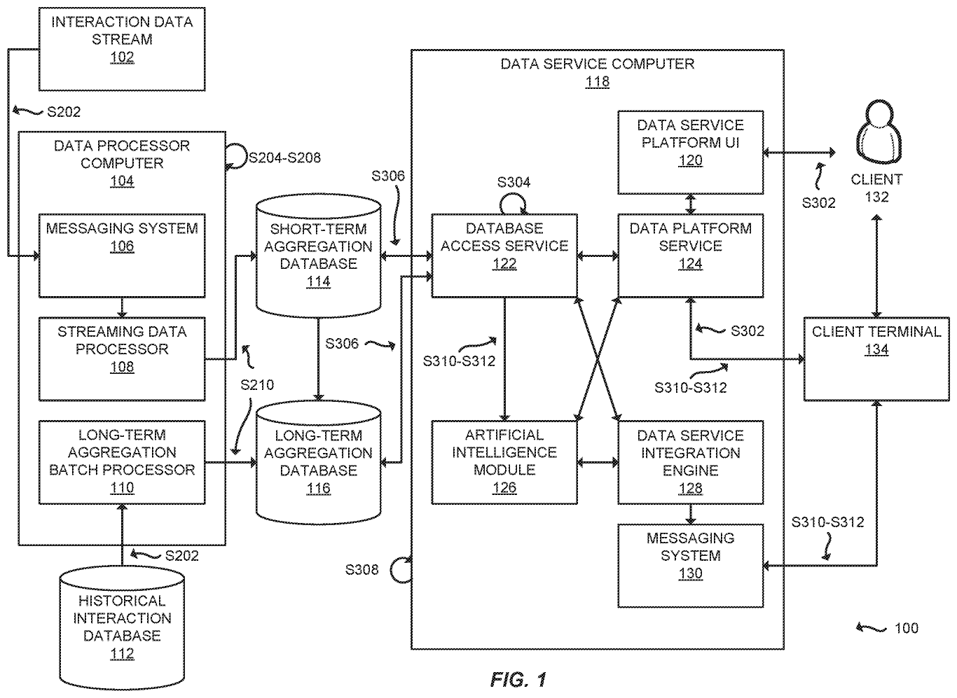

FIG. 1 shows a global AI platform 100 according to some embodiments.

The global AI platform 100 comprises an interaction data stream 102, a data processor computer 104, a historical interaction database 112, a short-term aggregation database 114, a long-term aggregation database 116, a data service computer 118, a client 132 and a client terminal 134. The computers, systems, databases, and entities of FIG. 1 may be in operative communication with one another via one or more communication networks.

A communications network can take any suitable form, which may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as but not limited to a Wireless Application Protocol (WAP), I-mode, and/or the like); and/or the like. Messages between the entities, providers, users, devices, computers and networks may be transmitted using a secure communications protocol such as, but not limited to, File Transfer Protocol (FTP); HyperText transfer Protocol (HTTP); Secure HyperText Transfer Protocol (HTTPS), Secure Socket Layer (SSL), ISO (e.g., ISO 8583) and/or the like.

Generally, the data processor computer 104 can receive a plurality of data sets corresponding to interaction events. These data sets may be received from the interaction data stream 102 and historical interaction database 112. The data processor computer 104 can generate aggregated and ordered data sets from the received plurality of data sets. Subsequently, the data processor computer 104 can store the aggregated and ordered data sets in an aggregated and ordered database. In some embodiments, the aggregated and ordered database may comprise multiple databases, i.e., the short-term aggregation database 114 and the long-term aggregation database 116.

Generally, the data service computer 118 receives requests from clients, such as client 132 or their respective client terminals (e.g., client computers), such as client terminal 134. These requests may be for a subset of data from the aggregated and ordered database. Alternatively, the requests may be for a prediction generated by artificial intelligence module 126 based on the subset of data. The data service computer 118 may retrieve a subset of data from the aggregated and ordered database and use it to service the client's 132 request. The requested data or prediction may be delivered to the client terminal 134 via either the data platform service 123 or the messaging system 130.

Methods and processes performed by the data processor computer 104, as well as related system components or modules will be described below with reference to FIGS. 1, 2, 4 and 5. Afterwards, methods and processes performed by the data service computer 118 will be described with reference to FIGS. 1, 3, and 6.

Before describing method steps S202-S210 in more detail, it may be useful to describe interaction events, data sets, data values, and data types in more detail.

An interaction event generally refers to an activity between two or more parties. An example of an interaction event is a transaction between a merchant and a customer. Another example of an interaction event is a pollution event (e.g., the emission of carbon dioxide into the atmosphere) between the polluter and the earth.

A data set corresponding to an interaction event is a set of data that describes or characterizes the interaction event. A data type can be the label, name, or identifier corresponding to a data value. For example, for a transaction interaction event, an exemplary data type is “amount spent” and the corresponding data value could be an amount of currency, e.g., $10.00. Other examples of data types include identifiers, such as a merchant category code (i.e., a number used to identify a category of merchant, e.g., the number 5411 could correspond to “grocery store”), or a payment account number (PAN) used to identify the account from which funds were drawn to pay the merchant during the transaction. Other examples of data types include zip codes and timestamps. As indicated, data values can correspond to both quantitative (e.g., amount spent) and qualitative (e.g., zip code) data types.

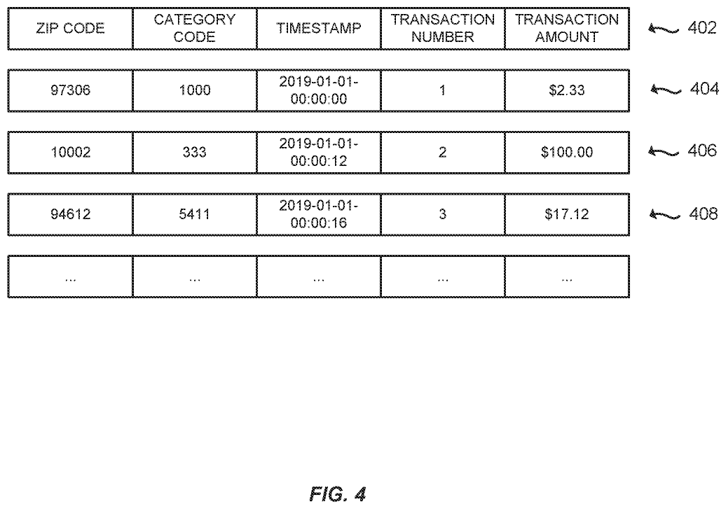

FIG. 4 shows some exemplary data sets 404-408 and corresponding data types 402 according to some embodiments. These exemplary data sets 404-408 correspond to transactions. Each exemplary data set comprises five data values, corresponding to the five data types 402: zip code, category code, timestamp, transaction number, and transaction amount.

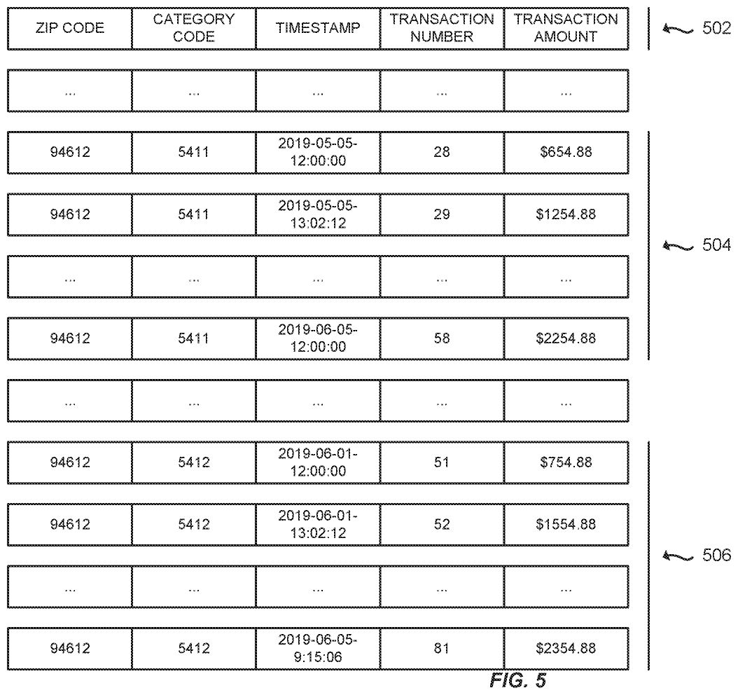

Data sets 404-408 are ordered based on timestamp and transaction number. However, unlike aggregated and ordered data sets (described in more detail below and with reference to FIG. 5), data sets 404-408 are neither grouped or aggregated. Data set 404 corresponds to the zip code 97306, data set 406 corresponds to the zip code 10002 and data set 408 corresponds to the zip code 94612. Likewise, each data set corresponds to a different category code.

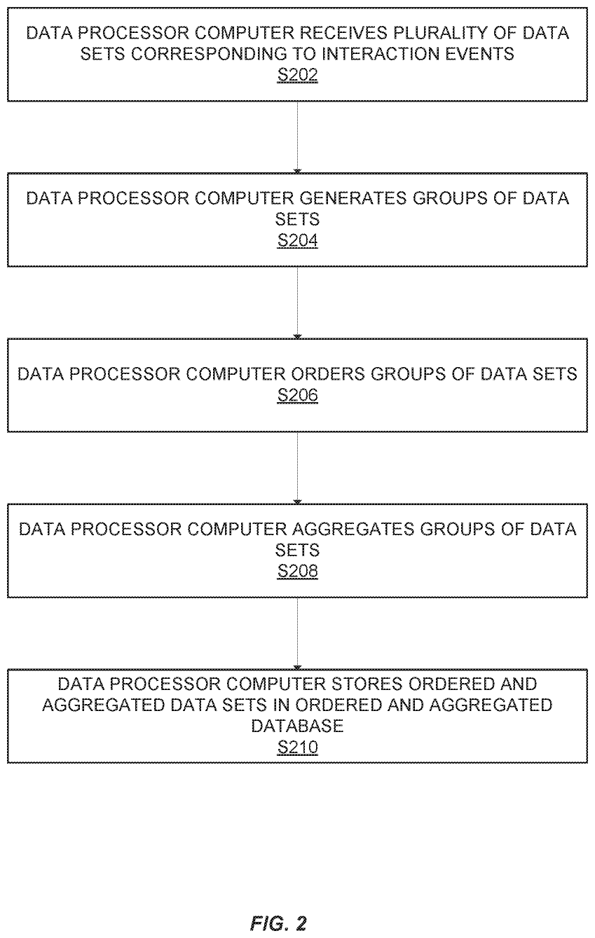

Returning to step S202 (see FIGS. 1 and 2), the data processor computer 104 can receive a plurality of data sets corresponding to a plurality of interaction events, each data set comprising a plurality of data values of different data types. In some embodiments, the plurality of data sets can comprise a first plurality of data sets and a second plurality of data sets, wherein receiving the plurality of data sets comprises receiving the first plurality of data sets from an interaction stream (e.g., interaction data stream 102) and the second plurality of data sets from a historical interaction database (e.g., historical interaction database 112).

In other words, as indicated by FIG. 1, data processor computer 104 may receive data sets from multiple sources, including interaction data stream 102 and historical interaction database 112.

Interaction data stream 102 may comprise a continuous or periodic source of interaction event data. For example, if the global AI platform 100 is used to provide pollution data to client 132 or predict future pollution, the interaction data stream 102 may comprise pollution sensing devices that are in the vicinity of industrial or mining zones, such as a networked collection of Internet of Things (loT) carbon dioxide and carbon monoxide sensors. These pollution sensing devices may stream collected data sets continuously or periodically (e.g., every minute, hour, day, etc.).

As another example, if the global AI platform 100 is used to provide business data to client 132 or make business predictions (e.g., sales for movie theaters in Austin Tex. six months into the future), the interaction data stream 102 may comprise a payment processing network, such as a network used for credit card transactions. Each time a transaction takes place, the interaction data stream 102 can transmit a data set corresponding to that transaction (e.g., comprising a timestamp, a zip code, a merchant category code, the amount spent, etc.) to the data processor computer 104. These data sets may be formatted according to any appropriate standard, such as ISO 8583, a standard for payment transaction data.

Data sets received by data processor computer 104 from interaction data stream 102 may be initially received or processed by messaging system 106. Messaging system 106 may comprise a software module used to receive data from interaction data stream 102. An example of messaging software is Apache Kaka, a stream-processing software platform. The messaging system 106 may convert data sets into key-value messages that can be interpreted and processed by streaming data processor 108.

Historical interaction database 112 may comprise a database containing data sets corresponding to a number of interaction events that took place in the past. The data sets stored in historical interaction database 112 may be unordered and unaggregated. The historical interaction database 112 may be a big-data repository, such as an Apache Hadoop distributed storage system. Historical interaction database 112 may store data sets corresponding to interaction events that took place prior to the implementation of global AI platform 100.

There may be a large number of data sets stored in the historical interaction database 112. As such, the data processor computer 104 may receive or retrieve data sets stored in the historical interaction database in batches. Each batch may comprise a number of data sets. Each batch may be a fixed number of data sets (e.g., 10,000) or an arbitrary number of data sets. Each batch may correspond to a particular time period (e.g., a one minute time period, one hour time period, one day time period, one year time period, etc.), such that each data set in the batch corresponds to the particular time period.

At step S204, data processor computer 104 can generate one or more groups of data sets, each group comprising one or more data sets having common data values of a common data type. For example, the plurality of data sets may comprise data values corresponding to the data type “zip code.” The data processor computer 104 may generate groups of data sets, where each group of data sets comprises data sets with the same zip code (e.g., one group has the zip code 94612, another group has the zip code 94613, etc.)

Step S204 may be performed simultaneously or sequentially by different software or hardware modules, depending on the source of the plurality of data sets.

Streaming data processor 108 can generate groups of data sets based on the data sets received from the interaction data stream 102, while the long-term aggregate batch processor 110 can generate groups of data sets based on the data sets received from the historical interaction database 112.

Generally, streaming data processor 108 may be a software or hardware module used to generate aggregated and ordered data sets based on received streamed data sets. This may involve performing functions or activities such as grouping data sets, (as performed in step S204), ordering groups of data sets (as performed in step S206), and aggregating ordered groups of data sets (as performed in step S208). Streaming data processor 108 may perform functions associated with allocating, managing, and manipulating memory, sorting or otherwise ordering blocks of memory, and performing mathematical functions associated with aggregation (e.g., addition) as part of grouping, ordering, and aggregating data sets.

Similarly, long-term aggregation batch processor 110 may be a software or hardware module used to generate aggregated and ordered data sets from batches of data sets received from historical interaction database 112. This may involve performing functions or activities such as grouping data sets, (as performed in step S204), ordering groups of data sets (as performed in step S206), and aggregating ordered groups of data sets (as performed in step S208). Long-term aggregation batch processor 110 may comprise code, executable by a processor for performing functions associated with allocating, managing, and manipulating memory, sorting or otherwise ordering blocks of memory, and performing mathematical functions associated with aggregation (e.g., addition) as part of grouping, ordering, and aggregating data sets.

At step S206, data processor computer 104 can, within each of the one or more groups of data sets, order the one or more data sets in each group according to time to form an ordered group of data sets. In some embodiments, each data set in the one or more groups of data sets may comprise a timestamp data value. The data processor computer 104 can order the data sets in each group according to time by ordering the data sets based on timestamp data values. For example, the data processor computer 104 can sort the data sets in each group such that each group comprises data sets that have sequentially increasing or decreasing timestamp data values. Like step S204, step S206 may be performed using the streaming data processor software module 108 or the long-term aggregation batch processor 110, depending on the source of the received data sets (i.e., interaction data stream 102 or historical interaction database 112).

Optionally, at step S206, data processor computer 104 can order the data sets in each group based on one or more data values corresponding to one or more common data types. That is, data processor computer 104 can order the groups of data sets based on factors other than time. Data sets corresponding to transaction interaction events can be ordered, for example, based on data values corresponding to merchant category codes, payment account numbers, or other data types.

Additionally or alternatively, data processor computer 104 can order the data sets in each group of data sets based on multiple factors, e.g., time and merchant category code. For example, data sets in a group can first be ordered by merchant category code, and within each merchant category code, the data sets can further be ordered by time.

At step S208, data processor computer 104 can, within each ordered group of data sets, for each data set, determine an aggregate data value for a data type, the aggregate data value determined by aggregating a data value corresponding to the data type for the data set with a cumulative total of data values of the data type for all preceding data sets in the ordered group of data sets, thereby creating an aggregated and ordered group of data sets.

In other words, for each ordered group of data sets and a particular data type (e.g., “amount spent” for transaction related data sets), the data processor computer 104 can determine a cumulative or moving sum of data values corresponding to that data type (hereinafter an “aggregated data value”). The aggregated data values can be associated with or included in the data sets of the ordered group of data sets. Alternatively, the aggregated data values can replace the data values that they aggregate.

The data processor computer 104 can aggregate the data sets based on the amount spent data type by determining a cumulative total of amount spent for each data value. For the first data set in an ordered group of data sets, the cumulative total is the relevant data value corresponding to that set itself (e.g., the amount spent for a transactional data set). For the second data set the cumulative total is the data value corresponding to the second data set, plus the cumulative total for all preceding data sets (in this case, just the cumulative total for the first data set). By the final data set, the cumulative total is the data value corresponding to the final set plus the cumulative total of all preceding data sets in the ordered group of data sets.

Aggregated and ordered data sets may be better understood with reference to FIG. 5, which shows data types 502 and two aggregated and ordered groups of data sets 504 and 506. These data sets correspond to transaction interaction events, and include data values corresponding to the data types: zip code, category code (e.g., merchant category code), transaction number, and transaction amount. The transaction amount data values are aggregate data values for each aggregated and ordered group of data sets.

Aggregated and ordered group of data sets 504 correspond to transaction that took place in the zip code 94612, with merchant category code 5411. Aggregated and ordered group of data sets 506 correspond to transaction that also too place in the zip code 94612, with merchant category code 5412. Data sets within each group are ordered based on timestamps.

Because of their aggregation and ordering, it is possible to quickly determine the total transaction amount for a given zip code and category code over an arbitrary time period. For example, to calculate the amount spent between May 5, 2019 at 12:00 P.M. and Jun. 5, 2019 at 12:00 P.M. for the merchant category 5411 (e.g., grocery stores) in the zip code 94612, the data service computer 118 only needs to subtract the aggregated transaction amount data value corresponding to the first data set from the aggregated transaction amount data value corresponding to the last data set of aggregated and ordered data sets 504, i.e., $2254.88-$654.88=$1600.00. This calculation only requires two database retrieval operations (corresponding to the first data set and the last data set) and a single subtraction operation.

By contrast, in a conventional database where the transaction amount is not aggregated, the data service computer 118 would have to perform a retrievals operation for all data sets between May 5^{th} and June 5^{th}, and perform an addition operation for each data set. For example, if 100,000 transactions took place between May 5^{th} and June 5^{th}, the data service computer 118 would have to perform 100,000 retrieval operations and 99,999 addition operations. This high number of operations greatly increases the time involved in calculating the result. Embodiments of the present disclosure, by contrast, only require two database retrieval operations and a single subtraction operation, providing a much quicker, more scalable solution.

Returning to FIGS. 1-2, at step S210, the data processor computer 104 may store the plurality of aggregated and ordered data sets in the aggregated and ordered database (e.g., the short-term aggregation database 114 and the long-term aggregation database 116). Aggregated and ordered data sets generated from data sets received from the interaction data stream 102 and processed by streaming data processor 108 may be stored in the short-term aggregation database 114, while data sets received from the historical interaction database 112 and processed by the long-term aggregation batch processor 110 may be stored in the long-term aggregation database 116.

The short-term aggregation database 114 and long-term aggregation database 116 may comprise any appropriate database systems or software used to store data sets. In some embodiments, the short-term aggregation database 114 and long-term aggregation database 116 may be NoSQL databases (i.e., databases that model data in means other than tabular relationships, as used in SQL (standard query language) databases or other relational database). Particularly, the short-term aggregation database 114 and long-term aggregation database 116 may comprise databases implemented with Redis, an in-memory key-value database.

Aggregated and ordered data sets may be stored in the short-term aggregation database 114 or long-term aggregation database 116 as strings. These strings may include any data type supported by the short-term aggregation database 114 and long-term aggregation database 116 (Redis strings, for example, can include JPEG images). These strings may also include more conventional text strings. A data set comprising [zip code: 94612, timestamp: Tuesday, aggregated amount spent: $9.00] can be represented by a string such as “94612:Tuesday:$9.00” and stored in short-term aggregation database 114 or long-term aggregation database 116 as such.

Data sets may be stored in the short-term aggregation database 114 or long-term aggregation database 116 in “sorted sets.” A sorted set may comprise a non-repeating collection of strings (i.e., the strings representing each data set), each member (data set) associated with a score, such that the set is ordered from the smallest score to the largest score.

As an example of the use of sorted sets, data sets among the aggregated and ordered data sets may be converted into strings, and the strings may be stored in the short-term aggregation database 114 or long-term aggregation database 116 as a sorted set. The “score” for each data set could correspond to the timestamp data value, or another relevant data value (e.g., zip code) such that the stored strings are ordered by time or zip code.

In some embodiments, the data sets stored in the short-term aggregation database 114 may correspond to only the most recent interaction events (e.g., interaction events that took place over the last 48 hours). As data sets become less recent (e.g., more than 48 hours has elapsed since the data set was stored in the short-term aggregation database 114), they may be transferred from the short-term aggregation database 114 to the long-term aggregation database 116. The long-term aggregation database 116 may hold data sets for a longer period of time, e.g., the last five years.

Data sets stored in the short-term aggregation database 114 and long-term aggregation repository 116 may be indexed. An index may refer to a data structure that links to other database entries or the memory address of other database entries. For example, an index may comprise a link to data sets corresponding to a particular zip code or a collection of zip codes (e.g., zip codes in a particular city, zip codes in a particular state, all zip codes in the United States, etc.). Indices may be used to quickly access data sets corresponding to a particular data value, without having to search the entire database to identify all data sets corresponding to that data value. Data sets stored in the short-term aggregation database 114 and long-term aggregation database 116 may be retrieved via batch calls, calls to the databases for more than one data set (e.g., all data sets corresponding to a particular region, such as a state).

The data service computer 118 and methods performed by the data service computer 118 will now be described with reference to FIGS. 1, 3, and 6. Generally, the data service computer 118 provides a data service to clients (such as client 132) as part of the global AI platform 100. This data service may involve providing data to client 132 such as data sets stored in the short-term aggregation database 114 and long-term aggregation database 116. Additionally, the data service may involve providing data derived from data sets stored in the short-term aggregation database 114 and long-term aggregation database 116, such as aggregated differences (i.e., the difference between an aggregated data value corresponding to one data set and an aggregated data value corresponding to another data set). Alternatively or additionally, the data service may comprise providing AI-generated predictions or answers to client requests or queries.

For example, the global AI platform 100 may comprise a global business AI platform used to sell business related data to client 132. For example, client 132 could request the total amount of money spent in grocery stores in the zip code 94612 over the last year, and the data service computer 118 can retrieve any relevant data sets from the short-term aggregation database 114 and long-term aggregation database 116 and transmit or otherwise provide that data to client 132. Alternatively, the client could ask for a business related prediction, and the data service computer 118 could use artificial intelligence module 126 to generate the prediction and provide the prediction to client 132.

Examples of client-generated requests for business related predictions include:

If I want to invest in a hotel, what is the best location in Texas for me to invest?

If I want to invest in Austin Tex., what business has the most potential profit?

What are the predicted sales of Merchant A in Austin Tex. six months from now?

What are the predicted sales of movie theaters in Austin Tex. six months from now?

If I can invest in a movie theater, car wash, or grocery store in Austin Tex., which one will be most profitable six months from now?

The data service computer 118 can interpret these requests, retrieve any relevant data sets from the short-term aggregation database 114 and long-term aggregation database 116, generate an input for a machine-learning model (or other artificial intelligence system), and generate the prediction using the artificial intelligence module 126. The prediction can then be returned to the client 132 via client terminal (e.g., client computer) 134.

It should be understood that the global AI platform 100 is not limited to business or transactional data, and can be used with any appropriate form of data or data sets. For example, the global AI platform 100 could be used to generate predictions related to pollution, such as:

In the next 10 years, what industry will be the greatest polluter in Texas?

What is the predicted concentration of carbon dioxide in the air in Austin Tex. six months from now?

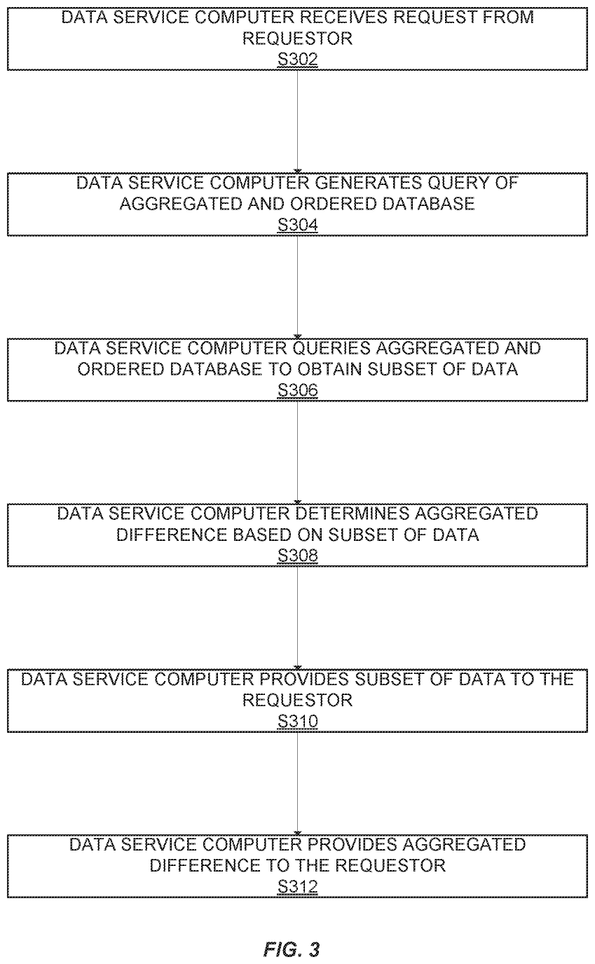

Referring to FIGS. 1 and 3, at step S302, the data service computer 118 can receive a request from a requestor. In some embodiments, the requestor may be a client terminal (e.g., client terminal 134) in communication with the data service computer 118. The client terminal 134 may be in communication with the data service computer 118 over a communication network such as the Internet. In other embodiments, the requestor may be a client 132 that interfaces directly with data service computer 118 (e.g., via a keyboard, monitor, or other input devices). In other embodiments, the requestor may be an artificial intelligence module (e.g., artificial intelligence module 126). Thus the requestor may be an external requestor (e.g., client 132 or client terminal 134) or an internal requestor (e.g., artificial intelligence module 126).

The request may take many forms. In some cases, the request may be a request for a prediction, such as the exemplary requests for predictions provided above. In other cases, the request may be a request for data or a subset of data from the aggregated and ordered database (e.g., the total sales of movie theaters in Austin Tex. between May 1, 2019 and June 1, 2019). In these cases, the requestor may be the client 132 or the client terminal 134.

The data service computer 118 may comprise or include a data platform service software module 124. The data platform service software module 124 may comprise any front-end or presentation layer software used to communicate with client terminals, such as client terminal 134. The data platform service software module 124 may also include any application programming interfaces (APIs) needed for the client terminal 134 to communicate with the data service computer 118 or transmit requests to the data service computer 118.

The data service computer 118 may also comprise a data service platform user interface (UI) software module 120. The data service platform UI software module 120 may provide any user interface code or elements enabling the client 132 to communicate with the data service computer 118, either directly (via a physical interface on the data service computer 118 itself) or indirectly, via client terminal 134. The data service platform UI software module 120 may comprise web elements (e.g., HTML, CSS, Javascript code, etc.) used to display a UI on a website that can be navigated to over the Internet. The client 132, using client terminal 134 may navigate to the website using a web browser in order to interact with the UI and communicate with the data service computer 118.

The data service platform UI software module 120 may comprise code implementing multiple distinct UI types. One exemplary UI type is a map-driven UI. The map-driven UI may comprise an interactive visual map that client 132 can use to request interaction event data. For example, the client 132 can use a mouse, touchpad, etc., to select a particular state (e.g., Texas) on the interactive visual map. The interactive visual map can then zoom in on the selected state and display the borders of counties or zip codes in the state. The interactive visual map can further display selectable graphical interface elements, such as buttons corresponding to different categories (e.g., grocery stores, movie theaters), as well as a slider bar that can be used to indicate a time range. Additionally, the data service UI platform software module 120 may support the generation and rendering of choropleth maps, such as a map that uses the color of states, counties, or zip codes to indicate some property of those states, counties, or zip codes (e.g., rendering counties where movie theaters are profitable as green and unprofitable as red).

In addition to map-driven UI, the data service platform UI software module 120 may comprise code, software, or instructions used to implement traditional form-based UI. A form-based UI may comprise multiple data fields such as text boxes, check boxes, radio buttons, submit buttons, drop-down menus etc. For example, the form-based UI could include a field that the client 132 can use to type out their query, or check boxes or a drop-drop menu used to select a particular state or region. Upon completing the form, the client 132 can click the submit button, at which point the request is interpreted from the form-based UI and transmitted to the data service computer 118.

In addition, client terminal 134 may also communicate with the data service computer 118 using REST (Representational State Transfer) services, services based on the REST software architectural style.

As stated above, in some cases, the requestor may be internal, e.g., the requestor may be the artificial intelligence module 126, requesting data in order to generate a prediction for client 132. For example, the artificial intelligence module 126 may be generating the predicted sales of movie theaters in Austin Tex. six months into the future using a machine learning model. The artificial intelligence module 126 may generate this prediction based on a subset of data stored in the short-term aggregation database 114 and long-term aggregation database 116. For example, the artificial intelligence module 126 may use the sales of movie theaters six, twelve, and eighteen months in the past in order to generate the prediction. The request may comprise a request for a subset of data sets corresponding Austin Tex., movie theaters, and six, twelve, and eighteen months into the past. The request may be any appropriate machine readable code, data, or message that can be interpreted by the database access service 122.

At step S304, the data service computer 118 may generate a query of an aggregated and ordered database (i.e., short-term aggregation database 114 and long-term aggregation database 116) based on the request. This query may be generated by the database access service 112.

The database access service 122 may be a software or hardware module used to retrieve data sets from the short-term aggregation database 114 and the long-term aggregation database 116. The database access service 122 may comprise code or instructions that enable it to generate queries and otherwise interface with the short-term aggregation database 114 and long-term aggregation database 116. These code or instructions may depend on the nature or implementation of the short-term aggregation database 114 and long-term aggregation database 116. For example, if the short-term aggregation database 114 and long-term aggregation database 116 are Redis databases, the database access service 122 may comprise code enabling the data service computer 118 to generate queries using Redis commands.

In some embodiments, generating the query of the aggregated and ordered database may comprise determining, based upon the request, one or more indices corresponding to one or more data values for one or more data types and generating the query of the aggregated and ordered database based on the one or more indices.

For example, if the request is a request for transactional data corresponding to movie theaters in Austin Tex., the indices may correspond to the category code for movie theaters and the zip codes corresponding to Austin Tex. Using these indices, the database access service 122 can quickly access the relevant data sets in the aggregated and ordered database (i.e., short-term aggregation database 114 and long-term aggregation database 116).

At step S306, the data service computer 118 can query the aggregated and ordered database (i.e., short-term aggregation database 114 and long-term aggregation database 116) using the query to obtain a subset of data from the aggregated and ordered data sets. That is, the data service computer 118 can use the query generated at step S304 and database access service 122 to request and receive the subset of data sets from the short-term aggregation database 114 and long-term aggregation database 116. For example, if the request is for data corresponding to sales at movie theaters in Austin Tex. over the past six months, the subset of data may comprise data sets corresponding to sales at movie theaters in Austin Tex. over that time period.

In some embodiments, the subset of data may comprise a first data set and a second data set. For example, the first data set may correspond to the aggregated movie theater sales in Austin Tex. six months ago and the aggregated movie theater sales in Austin Tex. at the current time. As described above with reference to FIG. 5, because these data sets are aggregated, it is possible to quickly calculate the total sales over the six month time period by subtracting the aggregated movie sales corresponding to the current time from the aggregated movie sales six months ago.

At step S308, the data service computer 118 can determine an aggregated difference by subtracting a first aggregated data value of the first data set from a second aggregated data value of the second data set. That is, as described above, the data service computer 118 can determine an aggregate data value corresponding to a time range (e.g., six months, twelve months, etc.) by subtracting the first aggregate data value from the second aggregate data value. This may be useful in case the request is for an aggregate data value corresponding to a time range (e.g., movie theater sales in Austin Tex. between 2012 and 2014), or in case an aggregate data value is an input to a machine learning model used to make a prediction (e.g., if the movie theater sales for 2020 are predicted based on the movie theater sales for 2019).

At step S310 the data service computer 118 can provide the subset of data to the requestor (i.e., the data retrieved from the aggregated and ordered database at step S306). Likewise, at step S312, the data service computer 118 can provide the aggregated difference to the requestor (i.e., the aggregated difference determined at step S308.

As stated above, in some embodiments, the requestor may be the client 132 or client terminal 134. In other embodiments, the requestor may be an internal requestor, e.g., artificial intelligence module 126. Embodiments involving an external requestor (client 132 or client terminal 134) will be discussed first, followed by embodiments involving an internal requestor.

The data service computer 118 can provide the subset of data and the aggregated difference to the client 132 and client terminal 134 via either the data platform service 124 or data service integration engine 128 and messaging system 130.

The data service computer 118 can provide the subset of data and the aggregated difference to the client terminal 134 via the communication channel between the data platform service 124 and client terminal 134, i.e., the same communication channel used to receive the request at step S302. For example, if the client terminal 134 communicates with the data service computer 118 via a data service API, the data service API can be used to communicate the subset of data and the and the aggregate difference to the client terminal. As an alternative, if the client terminal 134 communicates with the data platform service 124 via a web browser, the data platform service 124 can provide the subset of data and the aggregate difference to the client terminal via the web browser, from which the client 132 can download the subset of data and the aggregate difference to the hard drive of the client terminal 134.

In some embodiments, the subset of data and the aggregate difference can be provided to the client terminal 134 via the data service integration engine 128 and messaging system 130. Messaging system 130, like messaging system 106 may be a messaging service such as Apache Kafka. The data service integration engine 128 may comprise software code and instructions used to implement push-integration in conjunction with messaging system 130. For example, the data service integration engine 128 may comprise code enabling the generation of key-value messages from the subset of data and the aggregate difference, which can be pushed to a Kafka Cluster as a collection of topics divided into partitions. A topic can correspond to a particular geographic region (e.g., Austin Tex.) and partitions can correspond to different merchant categories within that region. Client 132, via client terminal 134 can subscribe to a particular topic and receive messages within a partition. Messaging system 130 can periodically push the latest updates to the client terminal 134. For example, client 132 can subscribe to the latest data on movie theater sales in Austin Tex., and each evening, receive a subset of data corresponding to movie theater sales, and an aggregate difference corresponding to movie theater sales over that day.

In other embodiments, the requestor may be artificial intelligence module 126, which may generate a prediction using the requested subset of data and the aggregate difference and subsequently transmit the prediction to the client terminal 134, via, for example, the data service integration engine 128 and messaging system 130 or data platform service 124 as described above.

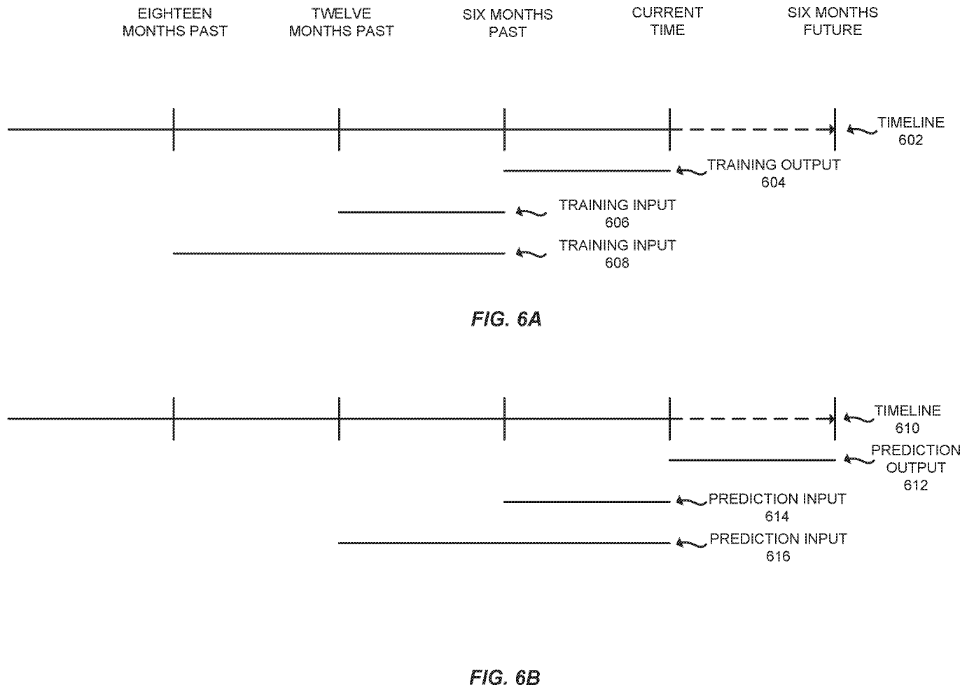

The artificial intelligence module 126 may comprise code or instructions used to implement machine learning models or other forms of artificial intelligence. These machine learning models may be trained to generate predictions using aggregated and ordered data sets, or data derived from aggregated and ordered data sets as inputs. Implementation details depend on the particular machine learning model implemented by artificial intelligence module 126. Implementing, training, and using a neural network may be accomplished in substantially a different way than implementing a support vector machine, logistic regression machine, etc. An example of training and using a generic machine learning model to generate predictions will be described in more detail with reference to FIGS. 6A and 6B.

FIGS. 6A and 6B illustrate the training and application of an exemplary machine learning model. The exemplary machine learning model can produce a prediction output 612 based on two prediction inputs 614-616. Prediction output 612 could, for example, be a prediction for how many sales movie theaters in Austin Tex. will make in the future. As illustrated by timeline 610, the prediction output 612 corresponds to a period of time six months from the present date. Prediction input 614 corresponds to a period of time 6 months before the present date and prediction input 616 corresponds to a period of time 12 months before the present date.

Thus the exemplary machine learning model produces a prediction of the future six months based on the prior six months and the prior twelve months, based on the observation that the near past correlates strongly with the near future. An example is predicting the population of deer in an area six months in the future based on the population of deer six months in the past and twelve months in the past. Another example is predicting the sales of a business six months in the future based on the sales six months in the past and twelve months in the past.

It should be understood that FIGS. 6A and 6B are intended only to illustrate one possible method of training and using a supervised machine learning model in order to make predictions. Embodiments may be practiced with multiple machine learning models, which may be supervised or unsupervised, and may have any number and variety of inputs and any number and variety of outputs.

Generally, during a training phase, the exemplary machine learning model learns correlations and relationships between known inputs and known outputs. During production, i.e., when the machine learning model is used to produce predictions, the machine learning model applies those correlations and relationships to known inputs to produce unknown outputs.

For the purpose of the example of FIGS. 6A and 6B, it is assumed that the characteristic of something in the immediate future (i.e., within six months from the current time) correlates most closely with the immediate past (i.e., within the past six months) and the near-immediate past (i.e., within the past twelve months). Thus the inputs to the machine learning model during the production phase (prediction inputs 614-616) correspond to the past six months and the past twelve months.

However, because the future is unknown, no training data exists for the future (e.g., the actual number of sales made by a specific business organization in the future, the actual population of deer in the future, etc.). As such, the machine learning model can be trained with an appropriate substitute, data corresponding to the prior six months (training output 604).

In effect, the time interval between six months past and the current time is treated as “the future” (corresponding to training output 604), the time interval from six months past to twelve months past (corresponding to training input 606) is treated as the previous six months, and the time interval from twelve months past to eighteen months past (corresponding to training input 608) is treated as the previous twelve months.

During the training phase (FIG. 6A) the machine learning model learns the correlations or relationship between data corresponding to training inputs 606-608 and the data corresponding to the training output 604. The exact manner or process by which these correlations or relationships are learned depends on the nature of the machine learning model being employed.

For example, a support vector machine is a machine learning model used for classification. A support vector machine may be used to produce a binary classification of an input, i.e., as belonging to one class or another class. A support vector machine may be used to answer queries such as “will a specific business be operational or out of business six months from now?” The support vector machine may use inputs such as the sales of the business over the previous six months and the sales of the business over the previous 12 months in order to produce an output prediction as to whether the business is in business or out of business.

Broadly, support vector machines determine the relationship between inputs (e.g., sales over 6 months, sales over 12 months) and outputs (e.g., in business, out of business) by determining the equation of a hyperplane that separates or otherwise divides training data belonging to one class (e.g., businesses that stayed in business) and the other class (e.g., businesses that went out of business) based on the input parameters (e.g., sales over six and twelve months). When the support vector machine is employed in production, it determines the location of a new data point, relative to the hyperplane (i.e., the side of the hyperplane that the new data point is on) and classifies it based on this location. If the new data point (i.e., sales over six months and twelve months) is on the side corresponding to businesses that stayed in business six months later, the support vector machine predicts that the business will stay in business. If the new data point is on the side corresponding to businesses that went out of business six months later, the support vector machine predicts that the business will go out of business.

By contrast, and again broadly, an artificial neural network determines the relationship or correlation between inputs and outputs as the weights between neurons of the neural network. The input to a neural network (e.g., the sales over the past six and twelve months) is provided to an input layer of artificial neurons. These artificial neurons output to one or more hidden layers which are composed of artificial neurons that in turn output to an output layer, corresponding to the output of the artificial neural network (e.g., the predicted sales over the next twelve months). The training process involves determining the weights between connected neurons, broadly speaking, corresponding to the influence the output of each neuron has on subsequent neurons of the neural network.

As illustrated, the nature of training depends on the machine learning model being employed. The training process can include determining relationships or correlations between the inputs and outputs (e.g., training inputs 606-608 and training output 604). The determined relationships or correlations between inputs and outputs are applied in production in order to make a prediction (prediction output 612) based on inputs (prediction inputs 614-616).

Returning to FIG. 1, upon generating the prediction using artificial intelligence module 126, the data service computer 118 can deliver the prediction to client 132 via the methods described above (e.g., via data platform service 124 or messaging system 130).

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

What is claimed is:

1. A method comprising:
receiving, by a data service computer, a request from a requestor;
generating, by the data service computer, a query of an aggregated and ordered database based on the request;
querying, by the data service computer, the aggregated and ordered database using the query to obtain a subset of data from aggregated and ordered data sets; and
providing, by the data service computer, the subset of data to the requestor.

2. The method of claim 1, wherein the requestor is a client terminal in communication with the data service computer.

3. The method of claim 1, wherein the requestor is an artificial intelligence module and wherein the artificial intelligence module produces a prediction by using the subset of data as an input to a machine learning model and transmits the prediction to a client terminal.

4. The method of claim 1, wherein the subset of data comprises a first data set and a second data set, and wherein the method further comprises:
determining, by the data service computer, an aggregated difference by subtracting a first aggregated data value of the first data set from a second aggregated data value of the second data set; and
providing, by the data service computer, the aggregated difference to the requestor.

5. The method of claim 1, wherein generating the query of the aggregated and ordered database comprises:
determining, by the data service computer, based on the request, one or more indices corresponding to one or more data values for one or more data types; and
generating, by the data service computer, the query of the aggregated and ordered database based on the one or more indices.

6. The method of claim 1, further comprising:
receiving, by a data processor computer, a plurality of data sets corresponding to a plurality of interaction events, each data set comprising a plurality of data values of different data types;
generating, by the data processor computer, one or more groups of data sets, each group comprising one or more data sets having common data values of a common data type;
within each of the one or more groups of data sets, ordering, by the data processor computer, the one or more data sets in each group according to time to form an ordered group of data sets;
within each ordered group of data sets, for each data set, determining, by the data processor computer, an aggregate data value for a data type, the aggregate data value determined by aggregating a data value corresponding to the data type for the data set with a cumulative total of data values of the data type for all preceding data sets in the ordered group of data sets, thereby creating an aggregated and ordered group of data sets; and
storing, by the data processor computer, a plurality of aggregated and ordered data sets in the aggregated and ordered database, wherein the plurality of aggregated and ordered data sets are a plurality of aggregated and ordered groups of data sets.

7. The method of claim 6, wherein the data processor computer is also the data service computer.

8. The method of claim 6, wherein each data set of the one or more groups of data sets comprises a timestamp data value, and wherein ordering the data sets in each group according to time comprises ordering the data sets based on timestamp data values

9. The method of claim 6, further comprising:
within each of the one or more groups of data sets, ordering, by the data processor computer, the data sets in each group based on one or more data values corresponding to one or more common data types.

10. The method of claim 6, wherein the plurality of data sets comprises a first plurality of data sets and a second plurality of data sets, and wherein receiving, by the data processor computer, the plurality of data sets comprises receiving the first plurality of data sets from an interaction stream and the second plurality of data sets from a historical interaction database.

11. A data service computer comprising:
a processor; and
a non-transitory computer readable medium coupled to the processor; the non-transitory computer readable medium comprising code, executable by the processor for implementing a method comprising:
receiving a request from a requestor,
generating a query of an aggregated and ordered database based on the request;
querying the aggregated and ordered database using the query to obtain a subset of data from aggregated and ordered data sets; and
providing the subset of data to the requestor.

12. The data service computer of claim 11, wherein the requestor is a client terminal in communication with the data service computer.

13. The data service computer of claim 11, wherein the requestor is an artificial intelligence module and wherein the artificial intelligence module produces a prediction by using the subset of data as an input to a machine learning model and transmits the prediction to a client terminal.

14. The data service computer of claim 11, wherein the subset of data comprises a first data set and a second data set, and wherein the method further comprises:
determining an aggregated difference by subtracting a first aggregated data value of the first data set from a second aggregated data value of the second data set; and
providing the aggregated difference to the requestor.

15. The data service computer of claim 11, wherein generating the query of the aggregated and ordered database comprises:
determining based on the request, one or more indices corresponding to one or more data values for one or more data types; and
generating the query of the aggregated and ordered database based on the one or more indices.

16. The data service computer of claim 11, wherein the data service computer is also a data processor computer, and wherein the method further comprises:
receiving a plurality of data sets corresponding to a plurality of interaction events, each data set comprising a plurality of data values of different data types;
generating one or more groups of data sets, each group comprising one or more data sets having common data values of a common data type;
within each of the one or more groups of data sets, ordering the one or more data sets in each group according to time to form an ordered group of data sets;
within each ordered group of data sets, for each data set, determining an aggregate data value for a data type, the aggregate data value determined by aggregating a data value corresponding to the data type for the data set with a cumulative total of data values of the data type for all preceding data sets in the ordered group of data sets, thereby creating an aggregated and ordered group of data sets; and
storing a plurality of aggregated and ordered data sets in the aggregated and ordered database, wherein the plurality of aggregated and ordered data sets are a plurality of aggregated and ordered groups of data sets.

17. The data service computer of claim 16, wherein each data set of the one or more groups of data sets comprises a timestamp data value, and wherein ordering the data sets in each group according to time comprises ordering the data sets based on timestamp data values.

18. The data service computer of claim 16, wherein the method further comprises:
within each of the one or more groups of data sets, ordering the data sets in each group based on one or more data values corresponding to one or more common data types.

19. The data service computer of claim 16, wherein different data types comprise one or more of: a geographic location, a category, a timestamp, an identifier, a first quantity, and a second quantity.

20. The data service computer of claim 16, wherein the plurality of data sets comprises a first plurality of data sets and a second plurality of data sets, and wherein receiving the plurality of data sets comprises receiving the first plurality of data sets from an interaction stream and the second plurality of data sets from a historical interaction database.
